(19) United States
(12) Patent Application Publication
(10) Pub. No.: US 2022/0099967 A1
(43) Pub. Date: Mar. 31, 2022

(54) OPTICAL IMAGING STRUCTURE

(71) Applicant: SITRONIX TECHNOLOGY CORP., JHUBEI CITY (TW)

(72) Inventors: CHUAN-PIN HSIUNG, JHUBEI CITY (TW); SHUN WEN CHENG, JHUBEI CITY (TW)

(21) Appl. No.: 17/034,542

(22) Filed: Sep. 28, 2020

(51) Int. Cl. G02B 27/01; B60K 35/00; B60J 1/02

(52) U.S. Cl. CPC G02B 27/0101; B60K 2370/334; B60J 1/02; B60K 35/00

(57) ABSTRACT

The present invention provides an optical imaging structure, which comprises a windshield. The windshield includes a first glass layer and a second glass layer spaced with the first glass layer by a fixed distance. A horizontal curvature of the first glass layer and the second glass layer is greater than 3.5 meters. A vertical curvature of the first glass layer and the second glass layer is greater than the horizontal curvature. When an optical imaging device works with the windshield for imaging, the double-image phenomenon may be reduced.

### FIELD OF THE INVENTION

The present invention relates generally to an optical structure, and particularly to an optical imaging structure capable of reducing double-image phenomenon.

### BACKGROUND OF THE INVENTION

Owing to the progresses of optical and electronic technologies, optical imaging devices, for example, projectors and liquid crystal displays, are developed continuously for various daily applications. Nowadays, heat-up displays (HUD) are developed for drivers as a driving assistance tool applied extensively to vehicles. With HUD, drivers do not need to look down for viewing the dashboard. Instead, drivers can see important driving information in their driving line of sight. By lowering the frequency of looking down for checking the dashboard, the attention will not be interrupted and the mastering for the driving status will not be lost. Hence, the driving safety can be enhanced.

Nonetheless, when an HUD projects images to a general windshield, where, as shown in FIG. 1, a first glass surface P1 and a second glass surface P2 of the general windshield G are equally spaced and are equivalent to two parallel surfaces, the image source IMS will project a main-image ray L1 and a double-image ray L2 to the first glass surface P1 and the second glass surface P2 of the windshield G. The main-image ray L1 will be reflected by the first glass surface P1 and form a main-image reflection ray R1 for forming a main-image light spot R1C on the first glass surface P1 and reflecting to an eye EYE of the driver. The double-image ray L2 is incident to the windshield G and refracted. Namely, it will pass through the first glass surface P1 and be refracted and reflected on the second glass surface P2 before it is emitted from the first glass surface P1 of windshield G and refracted to form a double-image reflection ray R2. Thereby, a double-image light spot R2C is formed on the first glass surface P1 and reflected to the eye EYE.

Refer again to FIG. 1. The eye EYE receives the main-image reflection ray R1 and the double-image reflection ray R2 of the image source IMS. In other words, a first virtual image I1 and a second virtual image I2 corresponding to the main-image light spot R1C and the double-image light spot R2C are formed in front of the windshield G. Since the first virtual image I1 and the second virtual image I2 do not overlap, the eye EYE will see them and hence forming ghost images. This is also called the double-image phenomenon. As shown in FIG. 2, the distance between the image source IMS and the windshield G is inversely proportional to the distance between the main-image light spot R1C and the double-image light spot R2C. Thereby, when the distance between the image source IMS and the windshield G is increased from 1000 millimeters to 8000 millimeters, the distance between the main-image light spot R1C and the double-image light spot R2C the shortened from 2 millimeters to nearly 0.25 millimeter. Nonetheless, the main-image light spot R1C and the double-image light spot R2C still do not overlap. Thereby, referring again to FIG. 1 and FIG. 2, the user's eye EYE will see the first virtual image I1 and the second virtual image I2, leading to the double-image phenomenon. For the HUD user, it will be difficult to identify the contents of the HUD.

To solve this problem, an exclusive windshield is required to work with an HUD. Unfortunately, in addition to the cost of HUD, consumers still need to pay for the costly exclusive windshield for HUD, such as wedge-shaped spherical glass. In general, the price for a car equipped with exclusive windshield for HUD will be higher.

Accordingly, the present invention provides an optical imaging structure for reducing the double-image phenomenon. Furthermore, the reliance on exclusive windshields for HUD may be lowered, and hence reducing both the cost for buying a car and the maintenance costs.

### SUMMARY

An objective of the present invention is to provide an optical imaging structure, which comprises a windshield. A horizontal curvature of the windshield is greater than 3.5 meters, and a vertical curvature of the windshield is greater than the horizontal curvature of the windshield. When the optical imaging device works with the windshield for imaging, the double-image phenomenon may be reduced.

To achieve the above objective, the present invention provides an optical imaging structure, which comprises a windshield. The windshield includes a first glass layer and a second glass layer. The first glass layer and the second glass layer are spaced each other by a fixed spacing. A horizontal curvature of the first glass layer and the second glass layer is greater than 3.5 meters, and a vertical curvature of the first glass layer and the second glass layer is greater than the horizontal curvature.

### BRIEF DESCRIPTION OF THE DRAWINGS

FIG. 1 shows an imaging schematic diagram of the optical imaging structure according to the prior art;

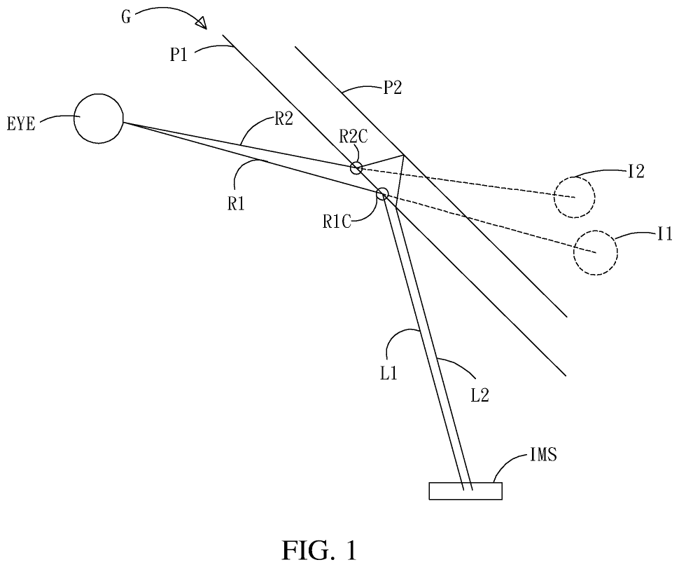

FIG. 2 shows a curve of the spacing distance between the main-image light spot and the double-image light spot versus the spacing distance between the image source and the windshield;

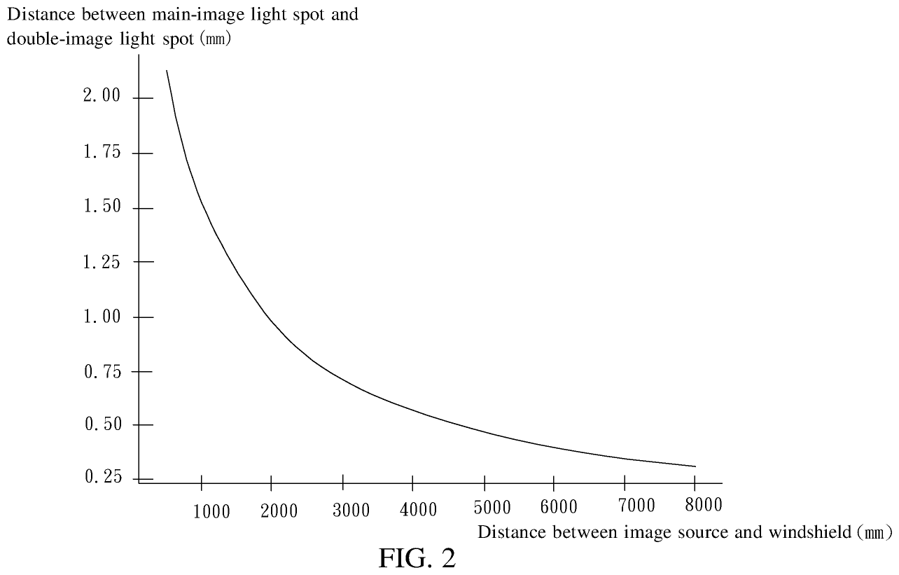

FIG. 3 shows a schematic diagram of the optical imaging structure according to an embodiment of the present invention;

FIG. 4 shows an imaging schematic diagram of the windshield with nonparallel surfaces according to the present invention;

FIG. 5 shows a curve of the spacing distance between the main-image light spot and the double-image light spot versus the spacing distance between the image source and the windshield;

FIG. 6 shows an imaging schematic diagram of the optical imaging structure according to an embodiment of the present invention;

FIG. 7 shows an imaging schematic diagram of the optical imaging structure according to an embodiment of the present invention; and

FIG. 8 shows a curve of the spacing distance between the main-image light spot and the double-image light spot versus the spacing distance between the image source and the windshield.

### DETAILED DESCRIPTION

In order to make the structure and characteristics as well as the effectiveness of the present invention to be further understood and recognized, the detailed description of the present invention is provided as follows along with embodiments and accompanying figures.

In the following description, various embodiments of the present invention are described using figures for describing the present invention in detail. Nonetheless, the concepts of the present invention may be embodied by various forms. Those embodiments are not used to limit the scope and range of the present invention.

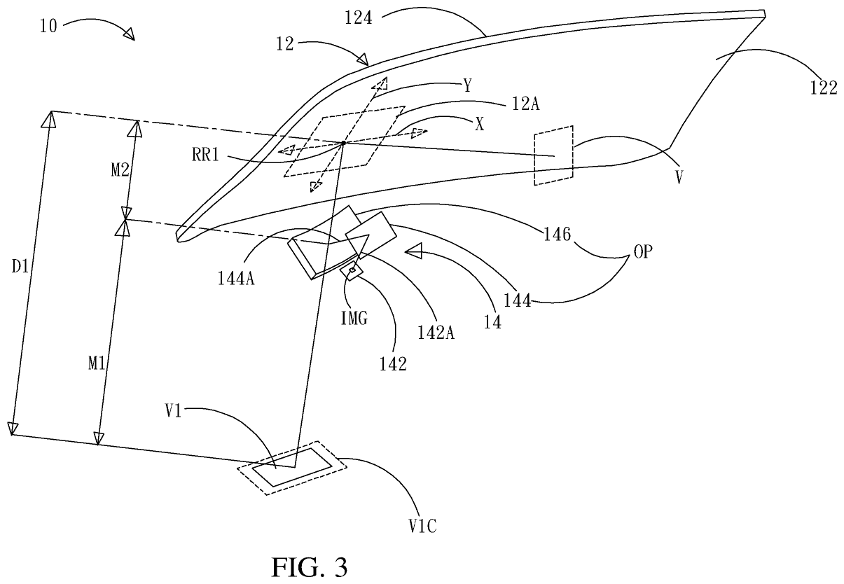

FIG. 3 shows a schematic diagram of the optical imaging structure according to an embodiment of the present invention. As shown in the figure, the optical imaging structure 10 according to the present invention comprises a windshield 12, which includes a first glass layer 122 and a second glass layer 124. The windshield 12 according to the present embodiment is a windshield for cars. The first glass layer 122 and the second glass layer 124 are spaced each other by a fixed distance. That is to say, the distance between the corresponding points on the first and second glass layers 122, 124 is fixed, meaning they are parallel glass layers. Besides, the first and second glass layers 122, 124 have curvatures. The center of circle for the first glass layer 122 coincides with the one for the second glass layer 124. The surface of the first glass layer 122 and the surface of the second glass layer 124 are parallel free surfaces.

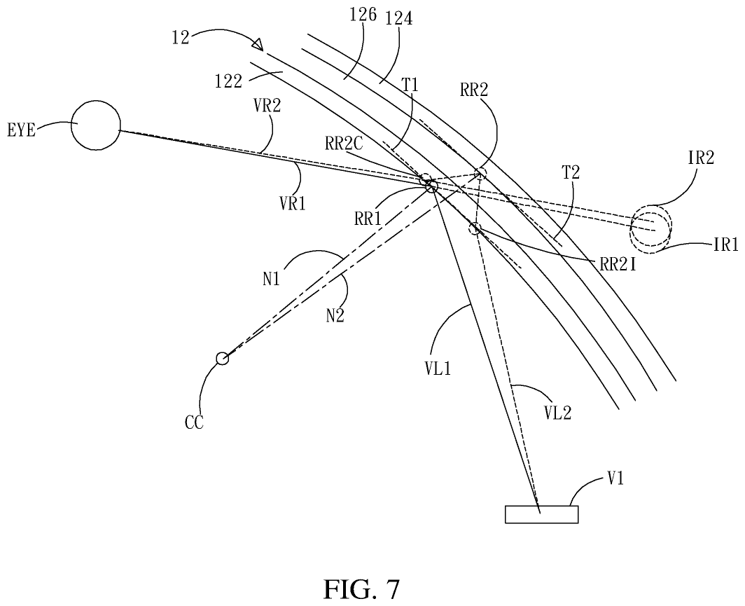

A first virtual image V1 acts as the image source. There is a distance between the virtual-image region V1C, where the first virtual image V1 is located, and the center of circle CC of the first and second glass layers 122, 124 of the windshield 12. Namely, the virtual-image region V1C is located at the place other than the center of the concentric circles, as shown in FIG. 7. A first reflection point RR1 is formed on the first glass layer 122 and corresponding to the visual region V.

Please refer again to FIG. 3. The optical imaging structure 10 according to the present embodiment further comprises an optical imaging device 14, which includes a display source 142 and an optical assembly OP. According to the present embodiment, the optical assembly OP further includes a reflection mirror 144 and a spherical mirror 146. The optical assembly OP is located on a first optical path 142A of the display source 142. In particular, the reflection mirror 144 is located on the first optical path 142A of the display source 142 and the spherical mirror 146 is located on a second optical path 144A of the reflection mirror 144. The display source 142 outputs an image IMG to the reflection mirror 144 for reflecting the image IMG to the spherical mirror 146. Thereby, the spherical mirror 146 projects the image IMG to the reflection region 12A on the windshield 12 and then to the visual region V. In addition, the first optical path 142A and the second optical path 144A may be smaller than the focal distance of the spherical mirror 146 for forming the first virtual image V1. It means that the optical assembly OP of the optical imaging device 14 corresponds to the reflection region 12A and forming the first virtual image V1. The optical imaging device 14 forms the first virtual image V1, which is located below the windshield 12 and acts as the image source. Thereby, the first virtual image V1 will form a reflection ray via the first reflection point RR1 and on the visual region V.

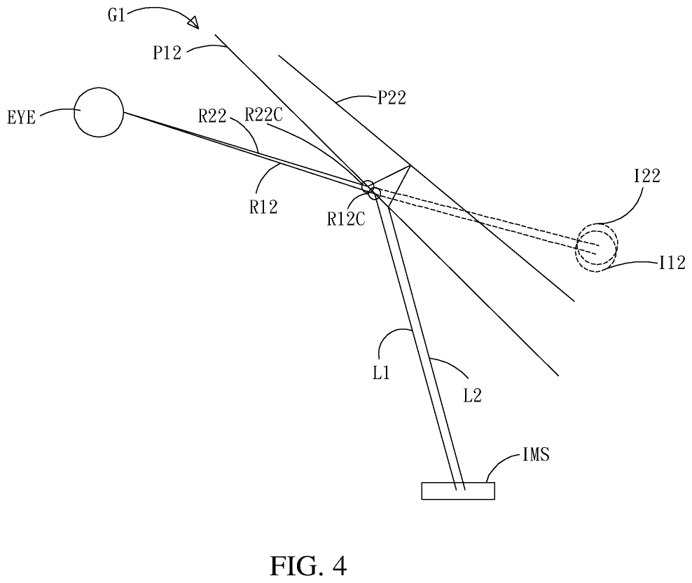

Please refer again to FIG. 3. The surfaces of the first and second glass layers 122, 124 are curved and free surfaces with the horizontal (X-axis) curvature greater than 3.5 meters and the vertical (Y-axis) curvature greater than the horizontal curvature. According to an embodiment of the present invention, the Y-axis curvature may be greater than 6 meters. The first virtual image V1 is located at the place other than the center of concentric circles of the first and second glass layers 122, 124, as shown in FIG. 7. Thereby, when the first virtual image V1 is projected to the windshield 12, the first reflection point of the first glass layers 122 reflecting the first virtual image V1 and the second reflection point of the second glass layers 124 reflecting the first virtual image V1 are located on nonparallel surfaces. As shown in FIG. 4, assume an angle, for example, 0.05 degree, is between the first plane P12 and a second plane P22 of the glass G1 with nonparallel surfaces. The glass G1 may be used as a windshield. When the image source IMS is located on one side of the glass G1 with nonparallel surfaces, the main-image ray L1 of the image source IMS will form a main-image light spot R12C on the first plane P12 and be reflected to form a main-image reflection ray R12 for projecting to the eye EYE. The double-image ray L2 of the image source IMS passes through the first plane P12 and is refracted before it is reflected by the second plane P22, passes through the first plane P12, and is refracted to form the double-image reflection ray R22. In other words, a double-image light spot R22C will be formed on the first plane P12. The double-image reflection ray R22 is also projected to the eye EYE. The eye EYE receives the main-image reflection ray R12 and the double-Image reflection ray R22 of the image source IMS corresponding to the main-image light spot R12C and the double-image light spot R22C and forming two virtual image I12, I22 in front of the glass G1.

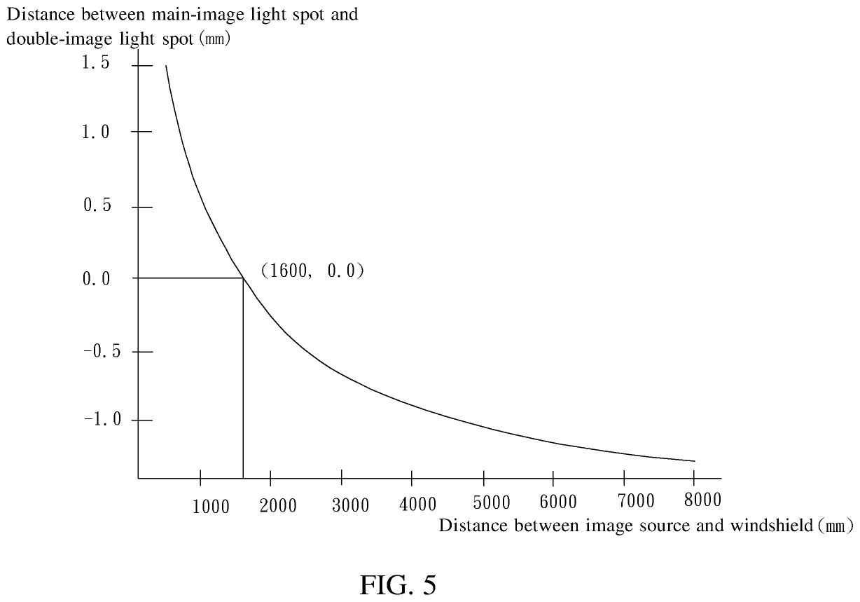

As shown in FIG. 5, as the distance between the image source IMS and the glass G1 is increased, the distance between the main-image light spot R12C and the double-image light spot R22C is reduced. According to the present embodiment, the distance between the main-image light spot R12C and the double-image light spot R22C is zeroed when the distance between the image source IMS and the glass G1 is about 1600 millimeters. Once the distance between the image source IMS and the glass G1 exceeds 1600 millimeters, the locations of the main-image light spot R12C and the double-image light spot R22C will cross over. For example, at first, the double-image light spot R22C is located above the main-image light spot R12C. As the distance between the image source IMS and the glass G1 exceeds 1600 millimeters, the double-image light spot R22C is located below the main-image light spot R12C. As the distance between the image source IMS and the glass G1 is increased, the distance between the main-image light spot R12C and the double-image light spot R22C is increased as well. The relation of the distance between the main-image light spot R12C and the double-image light spot R22C to the distance between the image source IMS and the glass G1 may be adjusted by adjusting the angle between the first plane P12 and the second plane P22. In other words, the distance between the image source IMS and the glass G1 when the distance between the main-image light spot R12C and the double-image light spot R22C is zero may be further adjusted.

Please refer again to FIG. 3. In the optical imaging structure 10 according to the present invention, a spacing distance D1 is between the first reflection region 12A and the first virtual image V1. The spacing distance D1 is equal to an imaging distance M1 between the spherical mirror 146 and the first virtual image V1 plus a projection distance M2 for projecting the image IMG to the reflection region 12A by the spherical mirror 146. In other words, the spacing distance D1 is equal to the imaging distance between the optical assembly OP and the first virtual image V1 plus the projection distance for projecting the image IMG to the reflection region 12A by the optical assembly OP. The spacing distance D1 is smaller than a half of the X-axis curvature X. In addition, the X-axis curvature X is greater than 3.5 meters and the Y-axis curvature Y is greater than the X-axis curvature X. Furthermore, the Y-axis curvature Y may be greater than 6 meters. Thereby, the double-image phenomenon may be reduced. Besides, the optical path of the image IMG to the optical assembly OP corresponds to the imaging distance M1 between the first virtual image V1 and the optical imaging device 14. That is to say, the distance between the display source 142 and the reflection mirror 144 (the distance of the first optical path 142A) and the reflection distance between the reflection mirror 144 and the spherical mirror 146 (the distance of the second optical path 144A) correspond to the imaging distance M1 between the first virtual image V1 and the optical imaging device 14.

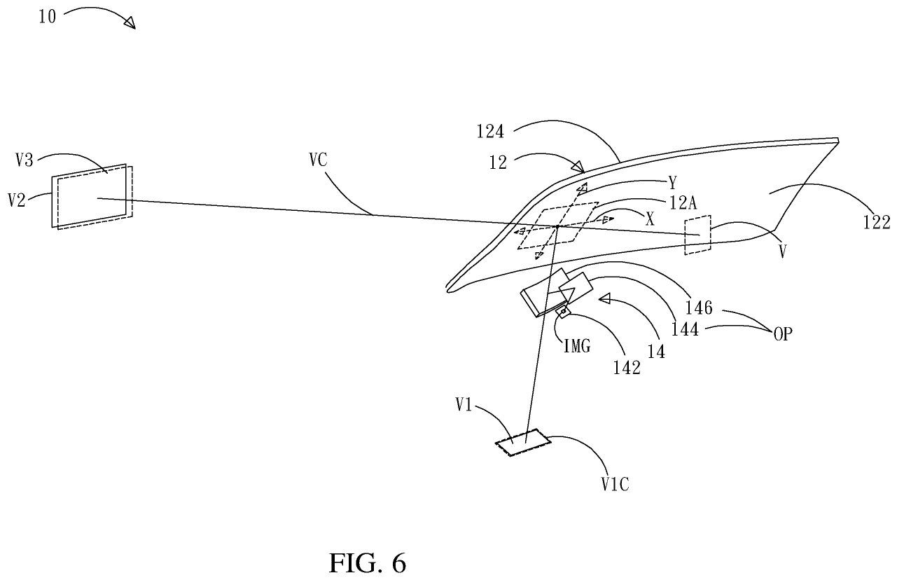

Please refer to FIG. 6 and FIG. 7, which show imaging schematic diagrams of the optical imaging structure according to an embodiment of the present invention. As shown in FIG. 6, the display source 142 is reflected by the optical assembly OP for projecting the image IMG to the windshield 12 and thus forming the first virtual image V1. In other words, the first virtual image V1 is formed corresponding to the spherical mirror 146. The virtual image V1 is located at a place in the reflection region 12A other than the center of concentric circles. The first virtual image V1 is equivalent to the image source projected to the windshield 12. The imaging distance between the optical assembly OP and the first virtual image V1 plus the reflection distance for projecting the image IMG to the reflection region 12A by the optical assembly OP is smaller than a half of the X-axis curvature. Thereby, the first virtual image V1 falls within the focal distance of the windshield 12 for forming the second virtual image V2 and the third virtual image V3. The second virtual image V2 corresponds to the main-image light spot and the third virtual image V3 corresponds to the double-image light spot.

Since the imaging distance between the optical assembly OP and the first virtual image V1 plus the reflection distance for projecting the image IMG to the reflection region 12A by the optical assembly OP is smaller than a half of the X-axis curvature, the X-axis curvature X is greater than 3.5 meters, and the Y-axis curvature Y is greater than the X-axis curvature X, the second virtual image V2 and the third virtual image V3 are formed at a distant place corresponding to the visual region V (the region in which the eye sees). By using the above conditions, the second virtual image V2 and the third virtual image V3 overlap on the line-of-sight direction VC of the visual region V and thus reducing the double-image phenomenon. Each point in the virtual region V1C corresponds to each point in the reflection region 12A.

As shown in FIG. 7, the first glass layer 122 and the second glass layer 124 include the first reflection point RR1 and the second reflection point RR2 corresponding to the first virtual image V1. The first glass layer 122 and the second glass layer 124 share the same center of circle and are concentric. The first normal N1 is the first reflection point RR1 to a center of concentric circle CC; the second normal N2 is the second reflection point RR2 to the center of concentric circle CC. The first virtual image V1 is not located at the center of concentric circle CC, meaning that the location of the first virtual image V1 corresponding to a place other than the location of the center of concentric circle. In other words, the first reflection point RR1 is located at a first location on the first glass layer 122; the second reflection point RR2 is located at a second location on the second glass layer 124; the first virtual image V1 is spaced with the center of circle of the first location (the center of concentric circle CC) and the center of circle of the second location (the center of concentric circle CC). Thereby, the first tangent T1 and the second tangent T2 corresponding to the first normal N1 and the second normal N2 own different tangent angles, meaning that the first tangent T1 and the second tangent T2 are not parallel. The first tangent T1 and the second tangent T2 do not correspond to the same normal. Thereby, the tangent points of the first and second tangents T1, T2 are different. The main-image ray VL1 and the double-image ray VL2 according to the embodiment in FIG. 4 are reflected by the nonparallel first plane P12 and second plane P22, respectively. The first reflection point RR1 is located on the first tangent T1; the second reflection point RR2 is located on the second tangent T2. Thereby, according to the corresponding descriptions for FIG. 4 and FIG. 5, using the windshield 12 according to the embodiment in FIG. 6 with the optical imaging device 14 may make the main-image light spot and the double-image light spot close and further overlap for reducing the double-image phenomenon. In addition, the windshield 12 further comprises a middle layer 126 disposed between the first glass layer 122 and the second glass layer 124.

Please refer again to FIG. 7. The first virtual image V1 projects the main-image ray VL1 and the double-image ray VL2 to the first glass layer 122. The main-image ray VL1 is reflected at the first reflection point RR1 on the first glass layer 122 and forming a main-image reflection ray VR1 for projecting to the eye EYE. The first reflection point RR1 is also the main-image light spot. The double-image ray VL2 passes through the first glass layer 122 and is refracted. It travels through the middle layer 126 and is incident to the second glass layer 124, forming an incident point RR2I. The double-image ray VL2 is refracted to the second glass layer 124 at the incident point RR21 for being reflected at the second reflection point RR2 on the surface of the second glass layer and forming the double-image reflection ray VR2. By means of the refraction by the first glass layer 122, the double-image light spot RR2C will be formed. Then the double-image reflection ray VR2 emits from the first glass layer 122 and is projected to the eye EYE. Since the first reflection point RR1 and the second reflection point RR2 are located on the nonparallel first tangent T1 and second tangent T2, respectively, the first reflection point RR1 and the second reflection point RR2 are located on two nonparallel surfaces of the glass G1. Thereby, the second virtual image V2 and the third virtual image V3 corresponding to the main-image reflection ray VR1 and the double-image reflection ray VR2 may overlap, and hence reducing the double-image phenomenon. Accordingly, the windshield 12 having parallel and free surfaces according to the present invention may reduce or eliminate the double-image phenomenon. The reliance on exclusive windshields for HUD may be lowered, and hence reducing both the cost for buying a car and the maintenance costs.

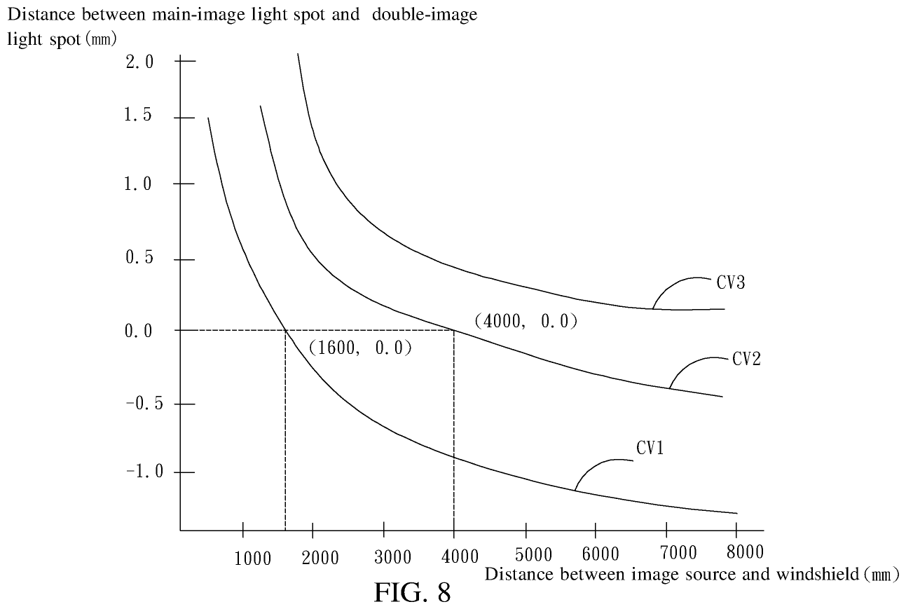

Please refer to FIG. 8. The first curve CV1 shows the distance between the main-image light spot and the double-image light spot versus the distance between the image source and the windshield in an optical structure formed by the windshield with nonparallel surfaces. The second curve CV2 shows the distance between the main-image light spot and the double-image light spot versus the distance between the image source and the windshield in an optical structure formed by the windshield according to the present invention. The third curve CV3 shows the distance between the main-image light spot and the double-image light spot versus the distance between the image source and the windshield in an optical structure formed by the windshield with normal parallel glass. According to the third curve CV3, for the windshield with normal parallel glass, the main-image light spot and the double-image light spot will never overlap no matter how the distance between the image source and the windshield increases.

Moreover, the horizontal curvature of the windshield on the optical imaging structure according to the present invention is greater than 3.5 meters, and the vertical curvature thereof is greater than the horizontal curvature. Thereby, according to the second curve CV2, the main-image light spot and the double-image light spot may overlap. For example, when the distance between the main-image light spot and the double-image light spot is zeroed, the distance between the image source and the windshield is about 4000 millimeters. Comparing the first curve CV1 and second curve CV2, for the costly windshield with nonparallel surfaces, the main-image light spot and the double-image light spot may overlap at a shorter distance between the image source and the windshield, which is about 1600 millimeters. Unfortunately, the windshield with nonparallel surfaces is more expensive, making it difficult to be applied extensively to all cars. Contrarily, the present invention provides an optical structure that enables HUDs to be applied extensively to all cars. Accordingly, the reliance on exclusive windshields for HUD may be lowered.

1. An optical imaging structure, comprising:
a windshield, including a first glass layer and a second glass layer spaced with said first glass layer by a fixed distance, a horizontal curvature of said first glass layer and said second glass layer greater than 3.5 millimeters, and a vertical curvature of said first glass layer and said second glass layer greater than said horizontal curvature.

2. The optical imaging structure of claim 1, wherein a first virtual image is located below said windshield, and said first virtual image is reflected by said windshield to form a second virtual.

3. The optical imaging structure of claim 2, wherein said first glass layer and said second glass layer include a first reflection point and a second reflection point corresponding to said first virtual image; said first reflection point is located on a first tangent; said second reflection point is located on a second tangent; and said first tangent and said second tangent are not parallel.

4. The optical imaging structure of claim 3, wherein said first reflection point is located at a first location on said first glass layer; said second reflection point is located on a second location on said second glass layer; and said first virtual image is spaced with a center of circle of said first location and a center of circle of said second location by a distance, respectively.

5. The optical imaging structure of claim 2, further comprising:
an optical imaging device, forming said first virtual image corresponding a reflection region on said windshield, wherein a spacing distance between said first virtual image and said reflection region is smaller than a half said horizontal curvature.

6. The optical imaging structure of claim 5, wherein said spacing distance is an imaging distance between said first virtual image and said optical imaging device plus a projection distance between said optical imaging device and said reflection region.

7. The optical imaging structure of claim 5, wherein said optical imaging device includes a display source and an optical assembly; and said display source outputs an image to said optical assembly for forming said first virtual image.

8. The optical imaging structure of claim 7, wherein said optical assembly includes a reflection mirror and a spherical mirror; and said reflection mirror reflects said image to said spherical mirror for forming said first virtual image.

9. The optical imaging structure of claim 8, wherein said spacing distance is an imaging distance between said first virtual image and said spherical mirror plus a projection distance between said spherical mirror and said reflection region.

10. The optical imaging structure of claim 5, wherein an optical path of said optical imaging device corresponds to an imaging distance between said first virtual image and said optical imaging device.

11. The optical imaging structure of claim 5, wherein a virtual-image region of said first virtual image corresponds to said reflection region.

12. The optical imaging structure of claim 1, wherein said vertical curvature is greater than 6 meters.

13. The optical imaging structure of claim 1, wherein said windshield includes a middle layer disposed between said first glass layer and said second glass layer.
